(19) United States
(12) Patent Application Publication
(10) Pub. No.: US 2013/0342476 A1
(43) Pub. Date: Dec. 26, 2013

(54) TOUCH PANEL

(71) Applicants: Seung Min Lee, Gyunggi-do (KR); Youn Soo Kim, Gyunggi-do (KR); Ha Yoon Song, Gyunggi-do (KR); Ho Joon Park, Gyunggi-do (KR)

(72) Inventors: Seung Min Lee, Gyunggi-do (KR); Youn Soo Kim, Gyunggi-do (KR); Ha Yoon Song, Gyunggi-do (KR); Ho Joon Park, Gyunggi-do (KR)

(73) Assignee: SAMSUNG ELECTRO-MECHANICS CO., LTD., Gyunggi-do (KR)

(21) Appl. No.: 13/591,998

(22) Filed: Aug. 22, 2012

(30) Foreign Application Priority Data
Jun. 22, 2012 (KR) 10-2012-0067458

(51) Int. Cl. G06F 3/041

(52) U.S. Cl. 345/173

(57) ABSTRACT

Disclosed herein is a touch panel, including a transparent substrate on which a wiring array is formed; a first connector formed on an end of the wiring array; a flexible printed circuit board (FPCB) on which a circuit terminal is formed; and a second connector formed on the circuit terminal and bonded to the first connector, in which a protrusion is formed on one of the first connector and the second connector and a groove is formed on the other one, thereby easily aligning the wiring array and the FPCB with each other and increasing the connection reliability therebetween.

### CROSS REFERENCE TO RELATED APPLICATION

This application claims the benefit of Korean Patent Application No. 10-2012-0067458, filed on Jun. 22, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

As computers using digital technologies have been developed, auxiliary equipment of computers has correspondingly been developed together. A personal computer, a portable transmitting apparatus, or other personal information processing apparatuses perform text and graphic processes by using various input devices such as keyboards, mouse, and the like.

However, along with the rapid development of an information-oriented society, computers have been widely used, and thus, it is difficult to effectively drive a product by using only a keyboard and a mouse, which presently function as an input device. Accordingly, there is an increasing need for a device to which anyone easily can input information via a simple method without miss handling.

Technologies for input devices have exceeded the standard for providing general functions and interest in input devices has changed toward high reliability, high durability, high innovation, design and process-related technologies. To this end, a touch panel has been developed as an input device for inputting information such as text, graphic, and so on.

A touch panel is a device that is installed on a display surface of a flat display apparatus such as an electronic notebook, a liquid crystal display device (LCD), a plasma display panel (PDP), or electroluminescence (EL) or a display surface of an image displaying apparatus such as a cathode ray tube (CRT) and is used for a user to select desired information while watching the image displaying apparatus.

A touch panel is classified into a resistive type touch panel, a capacitive type touch panel, an electro-magnetic type touch panel, a surface acoustic wave (SAW) type touch panel, and an infrared type touch panel. Such various types of touch panels are used in electronic products in consideration of issues of signal amplification, a resolution difference, difficulty in design and process technologies, optical properties, electrical properties, mechanical properties, environmental properties, input properties, durability, and economic feasibility. Currently, from among various types of touch panels, a resistive type touch panel and a capacitive type touch panel have been most commonly used.

An example of a conventional touch panel is disclosed in Korean Patent No. 10-1144152. In the touch panel disclosed in Korean Patent No. 10-1144152, an electrode pattern is formed on a transparent substrate. In addition, wiring extending from the electrode pattern is formed on the transparent substrate such that a flexible printed circuit board (FPCB) may be electrically connected to the electrode pattern.

A distal end of the wiring is disposed on an edge of the transparent substrate and the FPCB is fixed to the edge of the transparent substrate via a method such as an adhesion method to be electrically connected to the distal end of the wiring.

The FPCB needs to be connected to the wiring via a precision aligning process so as to prevent a contact failure with the wiring from occurring. However, since a conventional touch panel is configured in such a way that wiring is connected to an FPCB by simply bonding an end of the FPCB to an edge of a transparent substrate, as described above, it is not easy to precisely align the FPCB and the wiring with each other.

In addition, when the FPCB is aligned with the wiring, a pressuring process for fixing the FPCB onto the transparent substrate needs to be performed. Thus, during the pressuring process, the end of the FPCB moves and deviates from a desired position. Accordingly, a contact failure between the FPCB and the wiring occurs.

### SUMMARY OF THE INVENTION

The present invention has been made in an effort to provide a touch panel for easily aligning a flexible printed circuit board (FPCB) and wiring with each other.

Further, the present invention has been made in an effort to provide a touch panel for increasing the connection reliability between the FPCB and the wiring.

According to a preferred embodiment of the present invention, there is provided a touch panel including transparent substrate on which a wiring array is formed; a first connector formed on an end of the wiring array; a flexible printed circuit board (FPCB) on which a circuit terminal is formed; and a second connector formed on the circuit terminal and bonded to the first connector, wherein a protrusion is formed on one of the first connector and the second connector and a groove is formed on the other one, and wherein the first connector and the second connector are bonded to each other by inserting the protrusion into the groove.

The protrusion may be formed on an entire longitudinal region of any one of the first connector and the second connector, and the groove may be formed on an entire longitudinal region of the other one of the first connector and the second connector.

A plurality of protrusions may be formed in parallel to each other in a width direction of any one of the first connector and the second connector on any one of the first connector and the second connector, and a plurality of grooves may be formed in parallel to each other in a width direction of the other one of the first connector and the second connector in the other one of the first connector and the second connector.

The groove may have a width-direction cross section having a ‘V’ shape, and the protrusion may have a width-direction cross section having a triangular shape or an isosceles trapezoidal shape.

The first connector and the second connector may have the same length and width.

The touch panel may further include guiding portions that protrude from any one of the transparent substrate and the FPCB and are disposed adjacent to two width-direction sides of the first connector or the second connector, which is formed on any one of the transparent substrate and the FPCB, wherein, when the first connector and the second connector are bonded to each other, two width-direction sides of the first connector or the second connector, which is formed on the other one of the transparent substrate and the FPCB, are guided by one surface of each of the guiding portions.

A tapered surface may be formed on one surface of each of the guiding portions.

The first connector may be formed of the same material as the wiring array and may be integrated with the wiring array.

The second connector may be formed of the same material as the circuit terminal and may be integrated with the circuit terminal.

The first connector and the second connector may be bonded to each other using an anisotropic conductive film (ACF) or anisotropic conductive adhesive (ACA).

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a touch panel according to an embodiment of the present invention;

FIG. 2 is a cross-sectional view of a case where a first connector and a second connector shown in FIG. 1 are not bonded to each other, according to an embodiment of the present invention;

FIG. 3 is a cross-sectional view of a case where the first connector and the second connector shown in FIG. 2 are bonded to each other, according to an embodiment of the present invention;

FIG. 4 is a cross-sectional view of a touch panel according to another embodiment of the present invention; and

FIGS. 5A and 5B are cross-sectional views of a touch panel according to another embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, the present invention will be described in detail by explaining exemplary embodiments of the invention with reference to the attached drawings.

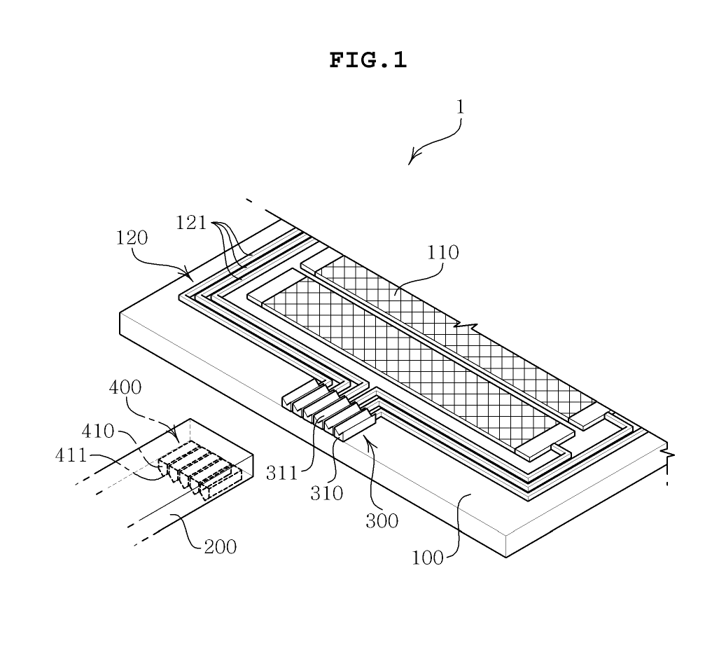

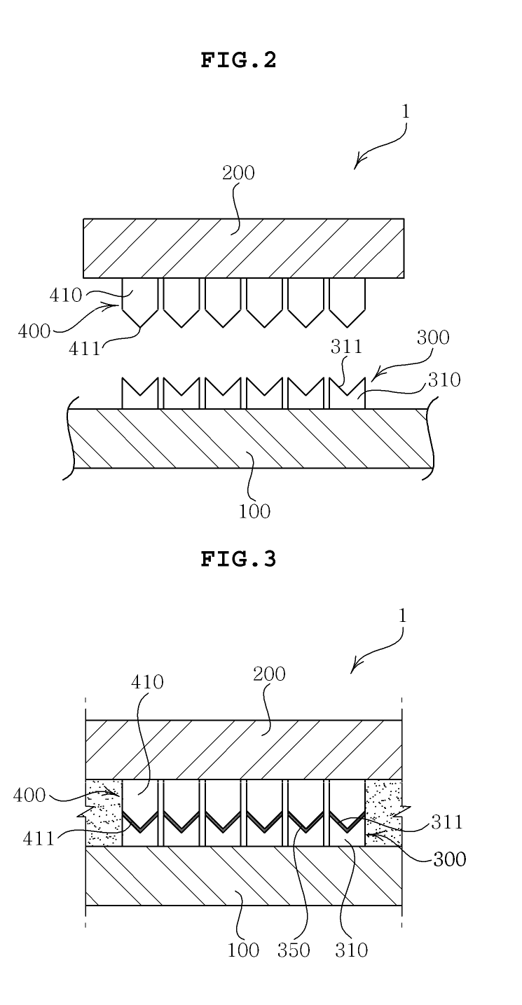

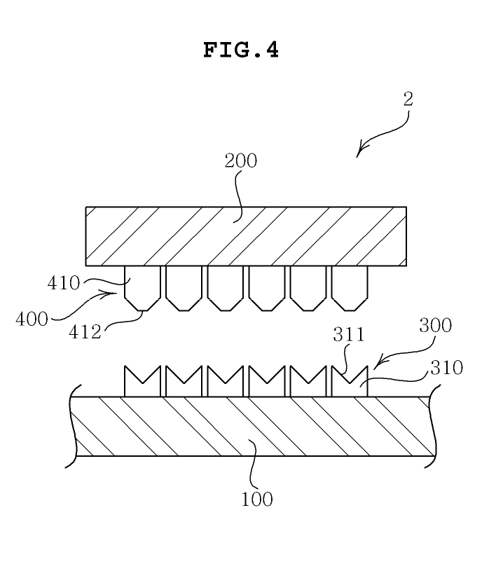

FIG. 1 is an exploded perspective view of a touch panel 1 according to an embodiment of the present invention. FIG. 2 is a cross-sectional view of a case where a first connector 300 and a second connector 400 shown in FIG. 1 are not bonded to each other, according to an embodiment of the present invention. FIG. 3 is a cross-sectional view of a case where the first connector 300 and the second connector 400 shown in FIG. 2 are bonded to each other, according to an embodiment of the present invention.

As shown in FIGS. 1 through 3, the touch panel 1 includes a transparent substrate 100 on which a wiring array 120 is formed, the first connector 300 formed on an end of the wiring array 120, a flexible printed circuit board (FPCB) 200 on which circuit terminals are formed, and the second connector 400 that is formed on the circuit terminals and is bonded to the first connector 300. In this case, any one of the first connector 300 and the second connector 400 includes protrusions 411 and the other one includes grooves 311. In addition, the first connector 300 and the second connector 400 are bonded to each other by inserting the protrusions 411 into the grooves 311.

The transparent substrate 100 may provide a region on which electrodes 110 and the wiring array 120 are to be formed. The transparent substrate 100 may have bearing power for supporting the electrodes 110 and the wiring array 120 and transparency for allowing a user to recognize an image provided by an image displaying apparatus.

In consideration of the above-described bearing power and transparency, the transparent substrate 100 may be formed of polyethyleneterephthalate (PET), polycarbonate (PC), polymethyl methacrylate (PMMA), polyethylenenaphthalate (PEN), polyether sulfone (PES), cyclic olefin polymer (COC), triacetylcellulose (TAC) film, polyvinyl alcohol (PVA) film, polyimide (PI) film, polystyrene (PS), biaxially oriented polystyrene (BOPS) (K resin-containing biaxially oriented PS), glass, tempered glass, or the like, but is not limited thereto.

The electrodes 110 may generate signals and may allow a controller (not shown) to recognize a touch coordinate when a user touches the touch panel. The signals generated by the electrodes 110 are transmitted to a controller (not shown) through wirings 121 included in the wiring array 120.

The wiring array 120 may include the wirings 121, the number of which is the same as the number of the electrodes 110. The wirings 121 may be formed of metal that has high electrical conductivity and is easily processed. Examples of the metal may include copper (Cu), aluminum (Al), gold (Au), silver (Ag), titanium (Ti), palladium (Pd), chromium (Cr), or a combination thereof.

One end of each of the wirings 121 is connected to each of the electrodes 110. The other end of each of the wirings 121 may be disposed on an edge portion of one surface of the transparent substrate 100, which is an inactive region.

When the wiring array 120 includes the plurality of wirings 121, the other ends of the wirings 121 may be disposed adjacent to each other on the edge portion of the transparent substrate 100 in consideration of the width of the FPCB 200 connected to the wiring array 120.

The other end of the wiring array 120 in which the other ends of the wirings 121 are disposed adjacent to each other is electrically connected to the FPCB 200 connected to a controller (not shown).

According to the present embodiment, the touch panel 1 includes the first connector 300 and the second connector 400, which electrically connect the wiring array 120 and the FPCB 200 to each other.

The first connector 300 is formed on the other end of the wiring array 120. When the wiring array 120 includes the plurality of wirings 121, the first connector 300 may include a group of first unit connectors 310 that are respectively formed at the wirings 121, as shown in FIGS. 1, 2, and 3.

In this case, the first unit connectors 310 may have different line widths and shapes from those of the wirings 121 and may be formed at ends of the wirings 121. In this case, the first connector 300 may be formed of the same material of the wirings 121 and may be integrated with the wirings 121. Alternatively, the first unit connectors 310 may be ends of the wirings 121 themselves.

The first unit connectors 310 may be arranged adjacent in parallel to each other, as shown in FIGS. 1, 2, and 3.

The second connector 400 is formed on circuit terminals (not shown) formed on one surface of the FPCB 200.

The number of the circuit terminals may be the same as the number of the wirings 121 that are electrically connected thereto. Thus, the second connector 400 formed on the circuit terminals may include a group of a plurality of second unit connectors 410, like the first connector 300. In addition, the second unit connectors 410 may have a different shape from the circuit terminals and may be separated from the circuit terminals. In this case, the second connector 400 may be formed of the same material as the circuit terminals and may be integrated with the circuit terminals. Alternatively, the second unit connectors 410 may be the circuit terminals themselves.

Any one of the first connector 300 and the second connector 400 includes the protrusions 411. In addition, the other one includes the grooves 311. For example, as shown in FIGS. 1 through 3, the protrusions 411 are formed on the second connector 400 and the grooves 311 are formed in the first connector 300. Hereinafter, the touch panel 1 will be described in terms of the case shown in FIGS. 1 through 3.

First, as shown in FIG. 1, the first connector 300 is formed to have a predetermined length and width. The second connector 400 is also formed to have a predetermined length and width. In this case, the first connector 300 and the second connector 400 may have the same length and width so as to minimize regions of the transparent substrate 100 and the FPCB 200, which are occupied by the first connector 300 and the second connector 400, and to maximize a bonding area between the first connector 300 and the second connector 400. As the bonding area between the first connector 300 and the second connector 400 is increased, the connection reliability between the wiring array 120 and the FPCB 200 may be increased.

The protrusions 411 formed on the second connector 400 may be formed on an entire longitudinal region of the second connector 400 in a longitudinal direction of the second connector 400. In addition, the grooves 311 formed in the first connector 300 may also be formed on an entire longitudinal region of the first connector 300 in a longitudinal direction of the first connector 300. This is also because the bonding area between the first connector 300 and the second connector 400 is maximized.

In addition, the protrusions 411 may be consecutively formed in a width direction of the second connector 400. As shown in FIGS. 1 through 3, when the second connector 400 includes the plurality of second unit connectors 410, the plurality of protrusions 411 may be formed on the second unit connector 410, respectively. In addition, the plurality of protrusions 411 are arranged in parallel to each other in a width direction of the second connector 400 including a group of the plurality of second unit connectors 410. One surface of the second connector 400 in which the plurality of the protrusions 411 are arranged in parallel to each other may correspond to an overall uneven surface formed in a width direction of the second connector 400.

The grooves 311 are also formed in a similar manner to the protrusions 411. The grooves 311 may be consecutively formed in a width direction of the first connector 300. As shown in FIGS. 1 through 3, when the first connector 300 includes the plurality of first unit connectors 310, the plurality of grooves 311 may be formed on the first unit connectors 310, respectively. In addition, the plurality of grooves 311 are arranged in parallel to each other in a width direction of the first connector 300 including a group of the plurality of first unit connectors 310. One surface of the first connector 300 in which the plurality of grooves 311 are arranged in parallel to each other may correspond to an overall uneven surface formed in a width direction of the first connector 300.

As shown in FIGS. 2 and 3, the grooves 311 may each have a width-direction cross section having a ‘V’ shape. In addition, the protrusions 411 may each have a width-direction cross section having a triangular shape.

This is because an area of the protrusions 411 corresponding to the grooves 311 is maximized when the protrusions 411 are inserted into the grooves 311. An angle of an inclination surface constituting each of the grooves 311 may be the same as an angle of an inclination surface constituting each of the protrusions 411, which corresponds thereto, such that surfaces of the protrusions 411 may overall correspond to surface of the grooves 311.

However, the protrusions 411 and the grooves 311 may not be limited to the above-described shapes. The protrusions 411 and the grooves 311 may have other various shapes.

A method of forming the uneven surface on one surface of each of the first connector 300 and the second connector 400 will now be described.

The wirings 121 included in the wiring array 120 may be formed on the transparent substrate 100 by using a plating method, a vapor deposition method, or the like. In particular, when the wirings 121 are formed of silver salt, the wirings 121 may be formed on the transparent substrate 100 via an exposure/develop process.

The ends of the wirings 121 themselves may be the first unit connectors 310. The first connector 300 may include a group of the first unit connectors 310 that are arranged adjacent to each other.

The first connector 300 may have an uneven surface that is formed by physically pressurizing one surface of the first connector 300 by using a pressurizer (not shown) having an uneven surface corresponding to the uneven surface to be formed on the first connector 300.

In addition, when the wirings 121 are formed of silver salt, the wirings 121 may shrink and be deformed when being dried during an exposure/develop process. Thus, during the exposure/develop process, an uneven surface may be formed. To this end, a separate mold having one side with an uneven surface formed thereon may be used. For example, the mold may be aligned on the transparent substrate 100 such that the uneven surface formed on the mold may contact one surface of the first connector 300. In addition, the uneven surface corresponding to the uneven surface formed on the mold may be formed on the first connector 300 of the wirings 121 formed of silver salt while the wirings 121 shrink.

An uneven surface may also be formed on the second connector 400 formed on the FPCB 200 by using various methods such as a pressuring method in which one surface of the second connector 400 is pressurized by using a separate pressurizer having one surface with an uneven surface formed thereon.

As shown in FIG. 3, the first connector 300 and the second connector 400 may be bonded to each other when a surface of the second connector 400, on which the protrusions 411 are formed, contacts a surface of the first connector 300, in which the grooves 311 are formed, so as to correspond to each other. In this case, in order to maintain a state when the first connector 300 and the second connector 400 are bonded to each other, the first connector 300 and the second connector 400 may be bonded to each other via an adhesive layer 350 interposed therebetween. The adhesive layer 350 may be formed of, for example, an anisotropic conductive film (ACF) or anisotropic conductive adhesive (ACA).

The first connector 300 and the second connector 400 may be bonded to each other by pressurizing the other surface of the FPCB 200 when the adhesive layer 350 is interposed between the first connector 300 and the second connector 400.

Since one surface of the first connector 300 and one surface of the second connector 400 may each constitute an uneven surface, as described above, a contact area with the adhesive layer 350 is increased as compared with a case where one surface of the first connector 300 and one surface of the second connector 400 may each constitute a flat surface. Thus, the first connector 300 and the second connector 400 may be very substantially bonded to each other.

Hereinafter a touch panel according to another embodiment of the present invention will be described with reference to the attached diagrams. However, details of the same components shown in FIGS. 1 through 3 will not be repeated.

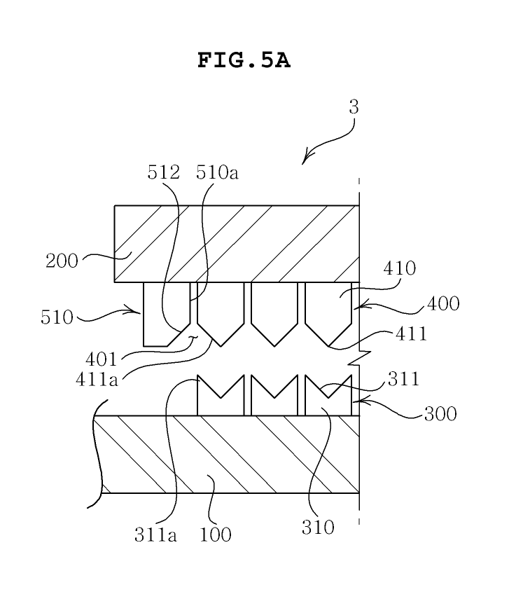

FIG. 4 is a cross-sectional view of a touch panel 2 according to another embodiment of the present invention.

As shown in FIG. 4, the touch panel 2 is different from the touch panel 1 shown in FIGS. 1 through 3 in terms of a detailed shape the protrusions 411 of the touch panel 1.

According to the present embodiment, protrusions 412 may each have a width-direction cross section having an isosceles trapezoidal shape. Since the protrusions 412 each have a width-direction cross section having an isosceles trapezoidal shape, front end portions of the protrusions 412, which are positioned in a lower portion with respect to FIG. 4, may each constitute a flat surface.

The grooves 311 have a minute width and depth. In this regard, if the protrusions 412 have a triangular shape, like in FIGS. 1 through 3, the protrusions 411 may not be inserted into the grooves 311 by as much as the depth of the groove 311.

Thus, in order to insert the protrusions 412 into the grooves 311 by as much as the height of the protrusion 412, the height of the protrusion 412 needs to be reduced. In order to reduce the height of the protrusions 412, the protrusions 412 may be obtained by cutting off front end portions of the protrusions 411 (refer to FIG. 3) having a cross section having a triangular shape such that the front end portions 412 may constitute a flat surface. The protrusions 412 may each have a cross section having an isosceles trapezoidal shape.

Hereinafter a touch panel according to another embodiment of the present invention will be described with reference to the attached diagrams. However, details of the same components shown in FIGS. 1 through 3 will not be repeated.

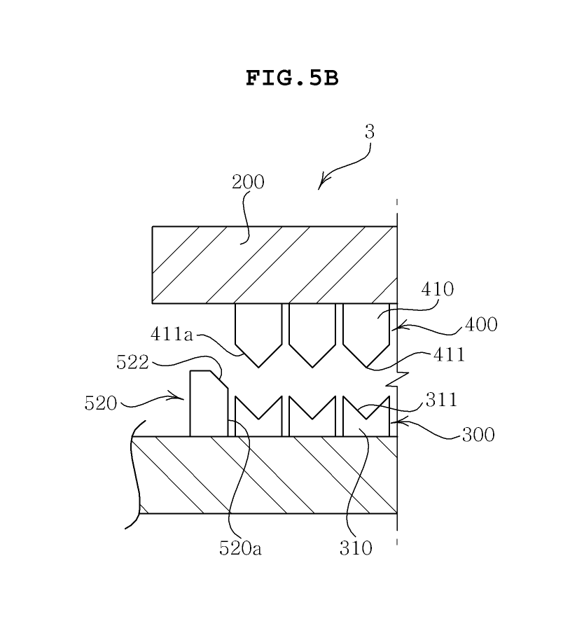

FIGS. 5A and 5B are cross-sectional views of a touch panel 3 according to another embodiment of the present invention.

According to the present embodiment, the touch panel 3 may further include guide portions that protrude from any one of the transparent substrate 100 and the FPCB 200 and are disposed adjacent to two width-direction sides of the first connector 300 or the second connector 400, which is formed on any one of the transparent substrate 100 and the FPCB 200, in addition to the touch panel 1 shown in FIGS. 1 through 3.

The guiding portions may prevent the first connector 300 and the second connector 400 that are bonded to each other from being offset from each other in a width direction.

In detail, the guiding portions may protrude from any one of the transparent substrate 100 and the FPCB 200. FIG. 5A shows a case where guiding portions 510 are formed on the FPCB 200. FIG. 5B shows a case where guiding portions 520 are formed on the transparent substrate 100.

First, referring to HG. 5A. the guiding portions 510 may protrude from one surface of the FPCB 200. The guiding portions 510 are disposed adjacent to the two width-direction sides of the second connector 400. The protruding height of the guiding portions 510 may be the same or greater than the height of the second connector 400.

The guiding portions 510 are configured such that an end surface 510a of each of the guiding portion 510 may face an inclination surface 411a of each of the protrusions 411 that are formed on the two width-direction sides of the second connector 400. In addition, a gap 401 is formed between the end surface 510a and the inclination surface 411a of each of the guiding portions 510.

When the first connector 300 and the second connector 400 are bounded to each other, an outermost side 311 a of the grooves 311 formed in two width-direction end portions of the first connector 300 may be guided by the end surface 510a of each of the guiding portions 510. That is, the outermost side 311a may be guided so as not to be offset out of the end surface 510a in a width direction. Thus, the first connector 300 and the second connector 400 may be bonded to each other so as not be offset from each other in a width direction.

FIG. 5B shows a case where the guiding portions 520 protrude from one surface of the transparent substrate 100. In addition, the guiding portions 520 are disposed adjacent to two width-direction sides of the first connector 300. The protruding height of the guiding portions 520 may be greater than the height of the first connector 300. In this case, ends of the guiding portions 520 are formed to be higher than the grooves 311 formed in the two width-direction sides of the first connector 300 to constitute side walls.

When the first connector 300 and the second connector 400 are bonded to each other, an outermost side 41 la of the protrusions 411 formed in two width-direction end portions of the second connector 400 may be guided by an end surface 520a of each of the guiding portions 520. The outermost side 411a may be guided so as not to be offset out of the end surface 520a in a width direction. Thus, the first connector 300 and the second connector 400 may be bonded to each other so as not to be offset from each other in a width direction.

As shown in FIGS. 5A and 5B, the guiding portions 510 and 520 may be configured in such a way that tapered surfaces 512 and 522 may be formed on the end surfaces 510a and 520a so as to easily guide the outermost side 411a of the protrusions 411 or the outermost side 311a of the grooves 311.

In the touch panels 1, 2, and 3 according to the above-described embodiments of the present invention, since the protrusions 411 and 412 and the grooves 311 are formed on the first connector 300 and the second connector 400 so as to correspond to each other, the wiring array 120 and the FPCB 200 may be easily aligned with each other.

In addition, according to the above-described embodiments of the present invention, when the plurality of protrusions 411 or 412 and the plurality of grooves 311 are formed, and surfaces of the first connector 300 and the second connector 400 constitute uneven surfaces corresponding to each other, the first connector 300 and the second connector 400 may be exactly aligned with each other during a bonding process of bonding the first connector 300 and the second connector 400 to each other without a separate aligning process of arranging the first connector 300 and the second connector 400 to face each other.

Furthermore, according to the above-described embodiments of the present invention, since surfaces of the first connector 300 and the second connector 400 constitute uneven surfaces instead of flat surfaces, a contact area between the first connector 300 and the second connector 400 is increased, thereby increasing the connection reliability between the first connector 300 and the second connector 400.

According to the present invention, since protrusions and grooves are formed on a first connector and a second connector so as to correspond to each other, a wiring array and an FPCB may be easily aligned with each other.

In addition, according to the present invention, when a plurality of protrusions and a plurality of grooves are formed, and surfaces of the first connector and the second connector constitute uneven surfaces corresponding to each other, the first connector and the second connector may be exactly aligned with each other during a bonding process of bonding the first connector and the second connector to each other without a separate aligning process of arranging the first connector and the second connector to each other.

Furthermore, according to the present invention, since surfaces of the first connector and the second connector constitute uneven surfaces instead of flat surfaces, a contact area between the first connector and the second connector is increased, thereby increasing the connection reliability between the first connector and the second connector.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A touch panel, comprising:
a transparent substrate on which a wiring array is formed;
a first connector formed on an end of the wiring array;
a flexible printed circuit board (FPCB) on which a circuit terminal is formed; and
a second connector formed on the circuit terminal and bonded to the first connector,
wherein a protrusion is formed on one of the first connector and the second connector and a groove is formed on the other one, and
wherein the first connector and the second connector are bonded to each other by inserting the protrusion into the groove.

2. The touch panel as set forth in claim 1, wherein the protrusion is formed on an entire longitudinal region of any one of the first connector and the second connector, and
wherein the groove is formed on an entire longitudinal region of the other one of the first connector and the second connector.

3. The touch panel as set forth in claim 2, wherein a plurality of protrusions are formed in parallel to each other in a width direction of any one of the first connector and the second connector on any one of the first connector and the second connector, and
wherein a plurality of grooves are formed in parallel to each other in a width direction of the other one of the first connector and the second connector in the other one of the first connector and the second connector.

4. The touch panel as set forth in claim 3, wherein the groove has a width-direction cross section having a V shape, and
wherein the protrusion has a width-direction cross section having a triangular shape or an isosceles trapezoidal shape.

5. The touch panel as set forth in claim 3, wherein the first connector and the second connector have the same length and width.

6. The touch panel as set forth in claim 5, further comprising guiding portions that protrude from any one of the transparent substrate and the FPCB and are disposed adjacent to two width-direction sides of the first connector or the second connector, which is formed on any one of the transparent substrate and the FPCB,
wherein, when the first connector and the second connector are bonded to each other, two width-direction sides of the first connector or the second connector, which is formed on the other one of the transparent substrate and the FPCB, are guided by one surface of each of the guiding portions.

7. The touch panel as set forth in claim 6, wherein a tapered surface is formed on one surface of each of the guiding portions.

8. The touch panel as set forth in claim 1, wherein the first connector is formed of the same material as the wiring array and is integrated with the wiring array.

9. The touch panel as set forth in claim 1, wherein the second connector is formed of the same material as the circuit terminal and is integrated with the circuit terminal.

10. The touch panel as set forth in claim 1, wherein the first connector and the second connector are bonded to each other using an anisotropic conductive film (ACF) or anisotropic conductive adhesive (ACA).
